(19) United States
(12) Patent Application Publication
(10) Pub. No.: US 2011/0033257 A1
(43) Pub. Date: Feb. 10, 2011

(54) HOLE SAW WITH TAPERED PILOT BIT

(76) Inventor: Wilbur Keith Moffatt, Freeport, IL (US)

Correspondence Address: CLARK HILL PLC, 150 NORTH MICHIGAN AVENUE, SUITE 2700, CHICAGO, IL, 60601, US

(21) Appl. No.: 12/850,843

(22) Filed: Aug. 5, 2010

Related U.S. Application Data
(60) Provisional application No. 61/231,722, filed on Aug. 6, 2009.

(51) Int. Cl. B23B 51/04; B23B 51/00

(52) U.S. Cl. 408/204; 408/226

(57) ABSTRACT

The present invention provides a hole saw and pilot bit assembly. The pilot bit of the assembly has a portion which is devoid of flute and lobes and a portion including flutes and lobes. The portion including flutes and lobes further includes a portion which is tapered.

This application claims the domestic benefit of U.S. Provisional application Ser. No. 61/231,722, filed on Aug. 6, 2009, which disclosure is hereby incorporated by reference in its entirety.

### BACKGROUND OF THE INVENTION

Hole saws are commonly used in connection with electric drills to create holes in a workpiece, such as sheet metal.

### SUMMARY OF THE INVENTION

The present invention provides a hole saw and pilot bit assembly. The pilot bit of the assembly has a portion which is devoid of flute and lobes and a portion including flutes and lobes. The portion including flutes and lobes further includes a portion which is tapered.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is an elevated view of the hole saw and pilot bit assembly of the present invention; and

FIG. 2 is a cross-sectional view of the hole saw and pilot bit assembly of FIG. 1 taken along line 2-2 of FIG. 1.

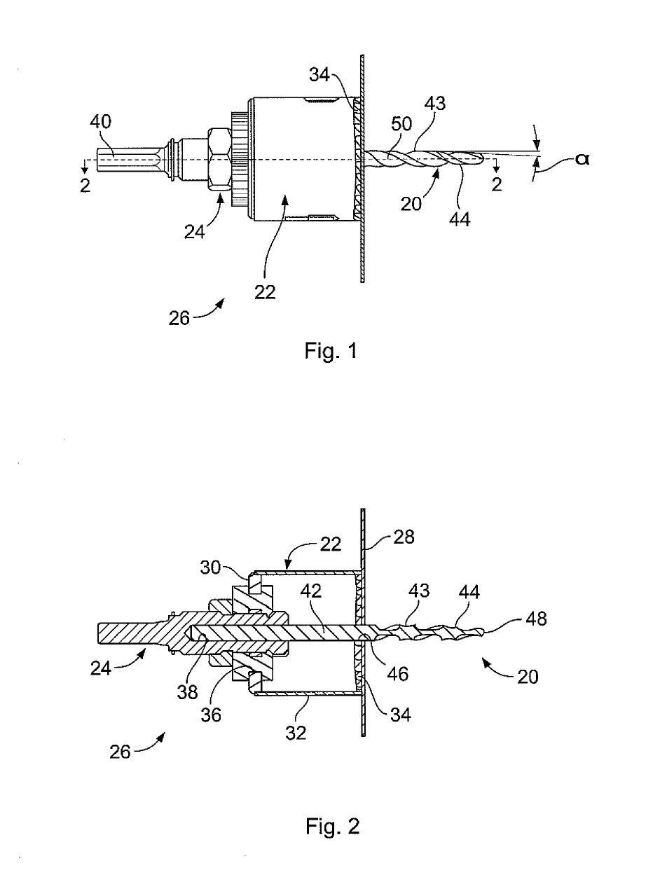

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

A pilot bit 20, a hole saw 22 and an arbor 24 are assembled to together to form an assembly 26 for cutting a hole in a workpiece 28, such as sheet metal. The pilot bit 20 is mounted to the arbor 24, and the arbor 24 is attached to the hole saw 22. The hole saw 22 and the arbor 24 are well-known in the prior art. For example, a suitable hole saw and arbor are shown in U.S. Pat. No. 7,112,016 which disclosure is herein incorporated by reference.

The hole saw 22 includes a circularly-shaped back plate 30 and a cylindrically shaped skirt 32 which depends from the back plate 30. A cutting edge 34 formed of a plurality of teeth are provided at the free end of the skirt 32. An aperture 36 is provided through the axial center of the back plate 30 through which the arbor 24 passes.

The arbor 24 includes a passageway 38 in one end into which the pilot bit 20 is removably attached. The arbor 24 has means 40 on the opposite end for engaging with a drive means (not shown).

The pilot bit 20 is formed of a shank that is divided into a first portion 42, a second portion 43 and a third portion 44. The first portion 42 includes a proximal end and a distal end; the second portion 43 includes a proximal end and a distal end; and the third portion includes a proximal end and a distal tip 48. The second portion 43 extends from a distal end of the first portion 42, and the third portion 44 extends from the distal end of the second portion 43.

The first portion 42 is formed as a cylindrical portion 42 which is devoid of flutes and lobes and therefore has a smooth exterior wall. The first portion 42 has a consistent diameter along its length, for example, a diameter of 0.150 inches. The second portion 43 is formed of a plurality of flutes and lobes. The outermost diameter of the second portion 43 is consistent along its length from its proximal end to its distal end. The outermost diameter of the second portion preferably has the same diameter as the first portion 42, for example, a diameter of 0.150 inches. The third portion 44 is also formed of a plurality of flutes and lobes. The outermost diameter of the third portion 44 tapers inwardly along its length, from its proximal end to the tip 48. The diameter of the third portion at its proximal end is the same as the diameter of the second portion 43 and tapers to the tip 48. For example, the third portion 44 tapers from a diameter of 0.150 inches at the junction with the second portion 43 to a diameter of 0.140 inches at the tip 48. The plurality of flutes and lobes on the second and third portions 43, 44 are used to drill a pilot hole 46 into the workpiece. The third portion 44 tapers from the second portion 43 to the tip 48 at a consistent angle relative to a centerline 50 of the pilot bit 20, for example at an angle of 3° as shown by the angle α.

The first portion 42 is provided along a substantial portion of the length of the pilot bit 20. For example, the first portion 42 extends for approximately two-thirds of the pilot bit 20, and the second and third flute and lobe portions 43, 44 extend for approximately one-third of the pilot bit 20. The second and third portions 43, 44 extend for approximately the same distance along the length of the pilot bit 20. As shown, each of the second and third portions 43, 44 extend for 0.75 inches and the first portion extends for approximately 3 inches.

The end of the first portion 42 is inserted in the passageway 38 in the arbor 24 and locked in place, for example by a set screw. The pilot bit 20 extends from the passageway 38 and through the hole saw 22. A predetermined length of the first portion 44, for example 0.050 inches extends beyond the outermost end of the cutting edge 34 of the hole saw 22. As a result, the second and third portions 43, 44 are completely outside of the hole saw 22.

When power is supplied, the drive means which is attached to the arbor 24, rotates the arbor 24. The rotation of the arbor 24 causes the pilot bit 20 to rotate and the hole saw 22 to rotate. The user applies pressure to the assembly 26 to cause the tip 48 of the pilot bit 20 to engage the workpiece 28 and pierce through the workpiece 28 to start the pilot hole 46. The user continues to apply pressure to the assembly 26 and then the third portion 44 engages the workpiece 28 and gradually widens the pilot hole 46 by virtue of the tapered provided thereon. This provides bio-feedback to the user early enough so that the user can reduce the force being applied to the assembly 26 as the piercing is finished. In addition, this provides the user with control as to how much pressure needs to be applied to have the hole saw 22 start the cutting of the workpiece 28. This becomes more significant as the tip 48 of the pilot bit 20 wears and the user applies significantly more force to cause the pilot bit 20 to drill the pilot hole 46.

As the assembly 26 is continued to be moved toward the workpiece 28 by the user applying pressure to the assembly 26, the second portion 43 of the pilot bit 20 cuts the pilot hole 46 and thereafter, the first portion 42 of the pilot bit 20 passes through the pilot hole 46 prior to engagement of the cutting edge 34 of the hole saw 22. The wall which forms the pilot hole 46 bears against the first portion 42 of the pilot bit 20. As the assembly 26 is further continued to be moved toward the workpiece 28 by the user applying pressure to the assembly 26, the cutting edge 34 of the hole saw 22 engages the workpiece 28 and cuts a circular hole into the workpiece 28. The pilot hole 46 continues to engage the first portion 42 of the pilot bit 20. The engagement of the pilot hole 46 with the first portion 42 of the pilot bit 20 prevents the flutes from routing out the pilot hole 46. If the flutes route out the pilot hole 26, the hole saw 22 will not be maintained in the correct position.

As a result of this configuration of the pilot bit 20, several benefits are produced. First, the amount of torque which is applied to the user's wrist is reduced, thereby reducing fatigue and increasing comfort and productivity. Second, the impact the hole saw 22 experiences as the hole saw 22 starts to cut is reduced, which helps to protect the cutting edge 34 from being damaged, thereby extending the life of the hole saw 22. Third, the pilot bit 20 also functions in wood without causing any negative issues with use the hole saw 22.

While a preferred embodiment of the present invention is shown and described, it is envisioned that those skilled in the art may devise various modifications of the present invention without departing from the spirit and scope of the appended claims.

The invention is claimed as follows:

1. A pilot bit comprising:
a shank including a first portion having a proximal end and a distal end, a second portion having a proximal end and a distal end, said second portion extending from said distal end of said first portion, and a third portion having a proximal end and a tip, said third portion extending from said distal end of said second portion;
wherein said first portion is devoid of flutes and devoid of lobes;
wherein the outermost diameter of said second portion is consistent from said proximal end to said distal end thereof; and
wherein the outermost diameter of said third portion tapers inwardly along a length of the third portion from the proximal end to the tip.

2. A pilot bit as defined in claim 1, wherein said first portion comprises approximately two-thirds the length of the pilot bit.

3. A pilot bit as defined in claim 1, wherein said second and third portions extend approximately one-third the length of the pilot bit.

4. A pilot bit as defined in claim 1, wherein the angle of taper is approximately three degrees.

5. A hole saw and pilot bit combination comprising:
a hole saw having a back plate, a skirt depending from said back plate, and a cutting edge at a distal end of said skirt; and
a pilot bit comprising; a shank including a first portion having a proximal end and a distal end, a second portion having a proximal end and a distal end, said second portion extending from said distal end of said first portion, and a third portion having a proximal end and a tip, said third portion extending from said distal end of said second portion;
wherein said first portion is devoid of flutes and devoid of lobes,
wherein the outermost diameter of said second portion is consistent from said proximal end to said distal end thereof; and
wherein the outermost diameter of said third portion tapers inwardly along a length of said third portion from the proximal end to the tip.

6. The combination as defined in claim 5, wherein said first portion of said pilot bit extends approximately two-thirds the length of the pilot bit.

7. The combination as defined in claim 5, wherein said second and third portions of said pilot bit extend approximately one-third the length of the pilot bit.

8. The combination as defined in claim 5, wherein the angle of taper of said pilot bit is approximately three degrees.

9. The combination as defined in claim 5, wherein the distal end of said first portion of said pilot bit extends distally beyond said cutting edge of said hole saw.

10. The combination as defined in claim 9, wherein the distal end of said first portion of said pilot bit extends distally beyond said cutting edge of said hole saw by approximately 0.05 inches.
